(19) United States
(12) Patent Application Publication
(10) Pub. No.: US 2025/0353731 A1
(43) Pub. Date: Nov. 20, 2025

(54) Device For Refilling a Final Container with Wine or Spirits, Refill Assembly Comprising such a Device and Method of Implementation

(71) Applicant: Société JAS HENNESSY ET COMPAGNIE, Cognac (FR)

(72) Inventor: Matthieu ACHARD, Cognac (FR)

(73) Assignee: Société JAS HENNESSY ET COMPAGNIE, Cognac (FR)

(21) Appl. No.: 18/854,710

(22) PCT Filed: Apr. 5, 2023
(86) PCT No.: PCT/FR2023/050491

§ 371 Date: Oct. 7, 2024

(30) Foreign Application Priority Data
Apr. 7, 2022 (FR) 2203217

(51) Int. Cl. B67D 3/00

(52) U.S. Cl. CPC B67D 3/0038; B67D 3/0048

(57) ABSTRACT

A device for refilling a final container with at least one wine or spirit, comprises a hollow body forming a reservoir, and, at or near a first end of the hollow body, separate first and second orifices which are in fluid communication with the reservoir. The first orifice is in fluid communication with the reservoir via a tube extending through the reservoir.

### TECHNICAL FIELD

This disclosure relates to the field of wines and spirits. More particularly, this disclosure relates to a device for refilling a final container with wine or spirits, a refill assembly comprising such a refill device, and a refill method which implements such a refill device.

### PRIOR ART

It is known to market wines or spirits, particularly cognac, in high-value containers. Such containers are in fact appreciated by customers, who see them as an additional sign of the quality of the wine or spirit contained therein.

However, these containers are generally thrown away once they are empty. This is a significant waste. The ecological footprint of the container could therefore be improved by making it possible to refill the container with wine or a spirit, particularly with wine or a spirit that is identical to what was initially held in the container.

However, such refilling is a delicate and complex process.

First of all, it is difficult to ensure that all of the wine or spirit initially contained in a refill container is actually transferred into the final container. The use of a simple funnel would be difficult for customers to accept.

Indeed, the wines or spirits contained in such final containers are generally high-value products, which must be handled with care so as not to alter or disturb them. Thus, directly filling an emptied final container from a refill container such as a refill bottle, using a simple funnel, does not seem to allow maintaining the taste and mouthfeel of the wine or spirit being refilled in the final container. In particular, when such a method is implemented, a stream of gas may appear, in the form of moving gas bubbles in the wine or spirit, which may impair the taste and mouthfeel of the wine or spirit.

Furthermore, known from document GB-A-2 220 408 is a closure device for closing a container, which comprises an inflatable element that can be placed inside the container. The closure device further provides a first passage for the removal of liquid from the container, and a second passage for filling the inflatable element with air as liquid is withdrawn from the container. The inflatable element prevents direct contact between the air and the liquid contained in the container, which could oxidize the liquid contained therein, in particular wine, and thus rapidly lower its quality. The closure device described in GB-A-2 220 408 is thus more particularly aimed at an application at a drink dispensing point, where a bottle may be kept for several days after it has been opened and only some of the liquid held in the container is extracted at a time, in order to serve a drink to a customer.

### SUMMARY

The present disclosure improves the situation.

A refill device for refilling a final container with at least one wine or spirit is proposed, comprising a hollow body forming a reservoir, and, at or near a first end of the hollow body, separate first and second orifices which are in fluid communication with the reservoir, the first orifice being in fluid communication with the reservoir via a tube extending through the reservoir.

Thus, advantageously, it is possible to channel a flow of gas in the tube, away from the wine or spirit to be refilled in the final container, which thus avoids altering the nature of the wine or spirit.

Preferably, the refill device comprises one or more of the following features, alone or in combination:
the first and second orifices are formed in a first endpiece fixed to the first end of the hollow body;
the first endpiece forms a valve for selectively placing the first orifice in fluid communication with the tube and the second orifice with the reservoir;
the first endpiece forms a first pipe adapted to place the first orifice in fluid communication with the tube, and a second pipe adapted to place the second orifice in fluid communication with the reservoir, a rod which forms a section of each of the first and second pipes being pivotally mounted relative to the first endpiece, for selectively allowing or blocking fluid communication through the first and second pipes;
the hollow body extends primarily in a main direction of extension, the hollow body having a dimension in the main direction of extension that is less than or equal to its dimensions in two directions perpendicular to the main direction of extension;
the hollow body is rotationally symmetrical relative to an axis extending parallel to the main direction of extension, the hollow body preferably having substantially the shape of an ellipsoid of revolution or a sphere flattened at one end;
the refill device further comprises a first mounting adapter for mounting on a final container, the first mounting adapter preferably being detachable from the hollow body or from the first endpiece when there is such;
the first mounting adapter forms a housing for receiving one end of the final container;
the first mounting adapter forms third and fourth pipes each adapted to place the first or second orifice respectively in fluid communication with the interior of the final container, the second orifice preferably further being in fluid communication with the interior of the final container via a tube intended to extend through the final container;
the hollow body is without any orifices other than the first and second orifices;
the hollow body forms a third orifice, at or near a second end of the hollow body, the third orifice being in fluid communication with the reservoir, the main direction of extension preferably corresponding to the direction from the first end towards the second end of the hollow body;
the third orifice is formed in a second endpiece, fixed to the second end of the hollow body;
the refill device comprises a baffle, preferably fixed to the tube or to the second endpiece when there is such, shaped to direct the at least one wine or spirit passing through the second orifice, towards a wall of the hollow body;
the refill device comprises a second mounting adapter for mounting at least one refill container on the refill device, the second refill adapter preferably being detachable from the hollow body or from the second endpiece when there is such;
the second mounting adapter forms a housing for receiving one end of the refill container;
the second mounting adapter forms a fifth pipe adapted to place the housing for receiving one end of the refill container in fluid communication with the third orifice;
the second mounting adapter forms a sixth pipe adapted to place the third orifice in fluid communication with a tube intended to extend through the refill container received in the second mounting adapter;
the second mounting adapter forms a valve which allows selectively cutting off the fluid communication through at least one among the fifth and sixth pipes if there are such; and
each among the first endpiece, the second endpiece, the first mounting adapter, and the second mounting adapter, if there are such, is made of stainless steel.

Also described is a refill assembly for refilling a final container with at least one wine or spirit, comprising: a refill device as described above in any of its combinations, the hollow body being without any orifices other than the first and second orifices; and a final container.

Also described is a refill assembly for refilling a final container with at least one wine or spirit, comprising: a refill device as described above in any of its combinations, the hollow body forming a third orifice at or near a second end of the hollow body, the third orifice being in fluid communication with the reservoir, the main direction of extension preferably corresponding to the direction from the first end to the second end of the hollow body; and at least one among at least one refill container and one final container; the refill assembly preferably comprising at least one refill container and one final container.

According to another aspect, a method for refilling a final container with at least one wine or spirit from at least one refill container is provided, comprising the steps of:
a) at least partially emptying the at least one refill container into the reservoir formed by the hollow body of a refill device as described above in any of its combinations, through the third orifice of the refill device; then
b) filling the final container from the refill device, through the first orifice.

Preferably, the method for refilling comprises an intermediate step between steps a) and b), consisting of separating the at least one refill container from the refill device, and, preferably, linking the final container to the refill device.

According to yet another aspect, an assembly is described comprising:
a first endpiece, intended to be fixed to a first end of a hollow body forming a reservoir, the first endpiece forming separate first and second orifices which are in fluid communication with the reservoir, the second orifice being in fluid communication with the reservoir via a tube extending through the reservoir; and
a first mounting adapter for mounting on a final container, the first mounting adapter preferably being detachable from the first endpiece, the first mounting adapter forming first and second pipes each adapted to place the first or the second orifice respectively in fluid communication with the interior of the final container, the second orifice preferably further being in fluid communication with the interior of the final container via a tube intended to extend through the final container.

### BRIEF DESCRIPTION OF DRAWINGS

Other features, details and advantages will become apparent upon reading the detailed description below, and upon analysis of the attached drawings, in which:

FIG. 1 schematically represents a front view of a first example of a refill device.

FIG. 2 schematically represents a longitudinal section view of the refill device of FIG. 1.

FIG. 3 schematically represents a longitudinal section view of the refill device of FIG. 1 linked to a refill container via a first mounting adapter for mounting the refill device on the refill container.

FIG. 4 schematically represents a longitudinal section view of the first mounting adapter for the refill device.

FIG. 5 schematically represents a longitudinal section view of the refill device of FIG. 1 linked to a final container via a second mounting adapter for mounting the refill device on the final container.

FIG. 6 schematically represents a longitudinal section view, along a first longitudinal section plane, of the second mounting adapter of the refill device.

FIG. 7 schematically represents a longitudinal section view, along a second longitudinal section plane perpendicular to the first longitudinal section plane, of the second mounting adapter of the refill device.

FIG. 8 schematically represents a longitudinal section view of a second example of a refill device linked to a final container via a mounting adapter for mounting the refill device on the final container.

### DESCRIPTION OF EMBODIMENTS

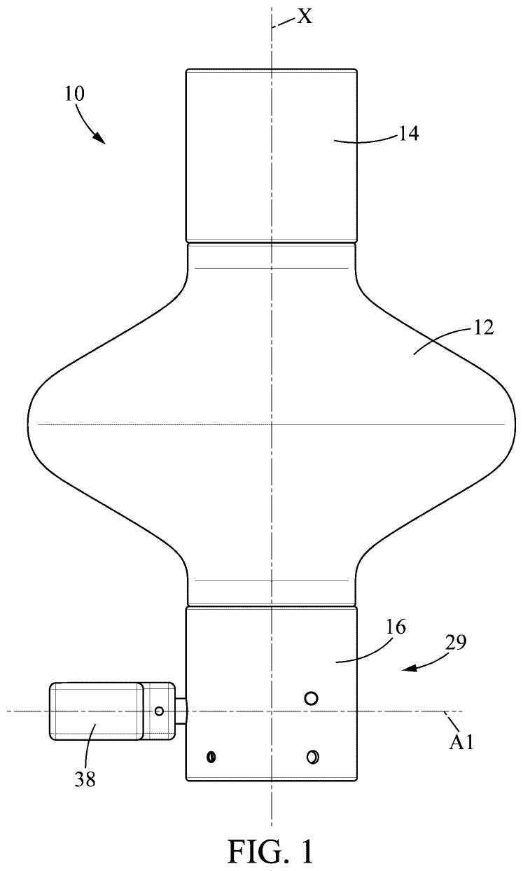

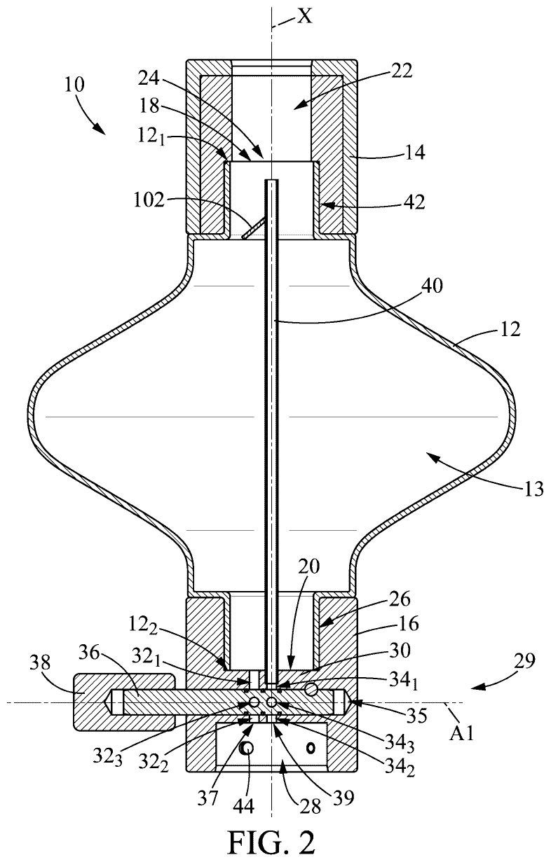

FIG. 1 and FIG. 2 show an example of a refill device 10 for refilling a final container with at least one wine or spirit.

As illustrated in these figures, refill device 10 essentially comprises a hollow body 12, forming a reservoir 13 adapted to contain liquid, and first 14 and second 16 endpieces.

Hollow body 12 extends primarily along an axis of extension X corresponding here to the main axis of extension of refill device 10. Here, in addition, hollow body 12 is rotationally symmetrical about axis of extension X. Hollow body 12 has a general shape that is substantially ellipsoid with two mouths 18, 20. More generally, hollow body 12 has a shape such that its height, measured in the direction of axis of extension X, is less than its width measured in a plane normal to axis of extension X. The two mouths 18, 20 of hollow body 12 are arranged at the two opposite ends 12₁, 12₂ of hollow body 12, along the direction of axis of extension X.

Hollow body 12 is for example made of transparent material, thus making it possible to monitor the filling and then the emptying of hollow body 12. Hollow body 12 is thus for example made of glass.

First endpiece 14 is fixed on hollow body 12 at first end 12₁. Preferably, first endpiece 14 is fixed on hollow body 12 in a liquid-tight manner, and more preferably in a gas-tight manner, in particular in an air-tight manner. First endpiece 14 here is hollow and substantially cylindrical. First endpiece 14 defines a first housing 22. First housing 22 here is cylindrical with a circular cross-section. First housing 22 has a mouth at a free end 14₁ of first endpiece 14. First housing 22 also has a mouth at a first orifice 24 which is in fluid communication with first mouth 18 of hollow container 12. The fluid communication between first orifice 24 and first mouth 18 is preferably liquid-tight, and more preferably is gas-tight, in particular air-tight.

Second endpiece 16 is fixed to hollow body 12, at second end 12₂ of hollow body 12. Preferably, second endpiece 16 is fixed to hollow body 12 in a liquid-tight manner, and more preferably in a gas-tight manner, in particular an air-tight manner. Second endpiece 16 is hollow and substantially cylindrical. More specifically, second endpiece 16 defines two hollow housings 26, 28, here of generally cylindrical shape, separated by a wall 30 extending in a plane normal to axis of extension X. A first housing 26 is oriented towards mouth 20 of hollow body 12. Here, mouth 20 of hollow body 12 is coincident with the mouth of first housing 26. Second housing 28 has a mouth at a free end of second endpiece 16, opposite mouth 20 of hollow body 12.

Furthermore, second endpiece 16 forms a double valve 29, adapted to allow or prevent fluid communication between first and second housings 26, 28, through two separate pipes 32, 34, each pipe 32, 34 preferably being liquid-tight, and more preferably gas-tight, in particular air-tight.

To create double valve 29, two first pipe sections 32₁, 34₁ and two second pipe sections 32₂, 34₂ are created in wall 30. Here, first and second pipe sections 32₁, 32₂, 34₁, 34₂ extend parallel to axis of extension X of refill device 10. More precisely, each first pipe section 32₁, 34₁ extends, in parallel to axis of extension X of refill device 10, face to face with a respective second pipe section 32₂, 34₂. First and second sections 32₁, 34₁, 32₂, 34₂ are separated by a cylindrical space 35, extending primarily in a plane normal to axis of extension X of refill device 10. A cylindrical rod 36 is received in cylindrical space 35, able to rotate freely about an axis A1 extending in a plane normal to axis of extension X of refill device 10. Cylindrical rod 36 is integral with a gripping piece 38 to facilitate manipulation, in particular rotation about axis A1. In cylindrical rod 36 are created third pipe sections 32₃, 34₃ which are adapted to be selectively arranged face to face with respective first and second pipe sections 32₁, 32₂, 34₁, 34₂. Cylindrical rod 36 thus allows selectively placing first pipe sections 32₁, 34₁ each in fluid communication with a respective second pipe section 32₂, 34₂. Seals are arranged along cylindrical rod 36, so that the fluid communication between first and second pipe sections 32₁, 32₂, 34₁, 34₂ established by third pipe sections 32₃, 34₃ is liquid-tight and preferably gas-tight, in particular air-tight. Here, three seals are used, one of them arranged along cylindrical rod 36, between the two third pipe sections 32₃, 34₃. The seals used are for example O-rings.

Each of second sections 32₂, 34₂ of the two pipes 32, 34 has a mouth leading into second housing 28 of second endpiece 16, through a respective orifice 37, 39.

One 34₁ of first pipe sections 32₁, 34₁ here receives a tube 40 which extends parallel to axis of extension X of refill device 10, here into a cavity 42 formed in first endpiece 14, facing mouth 18 of hollow body 12. Thus, here, tube 40 passes all the way through hollow body 12. Tube 40 thus places first section 34₁ in fluid communication with the interior of hollow body 12, preferably in a liquid-tight manner and more preferably in a gas-tight manner, in particular an air-tight manner.

Finally, pins 44 extend radially from the cylindrical wall of second housing 28. Pins 44 are preferably arranged within housing 28, symmetrically relative to axis of extension X of refill device 10. There are for example two pins 44. Pins 44 may in particular be cylindrical with a circular cross-section, each pin 44 extending primarily along an axis comprised in a plane normal to axis of extension X of refill device 10.

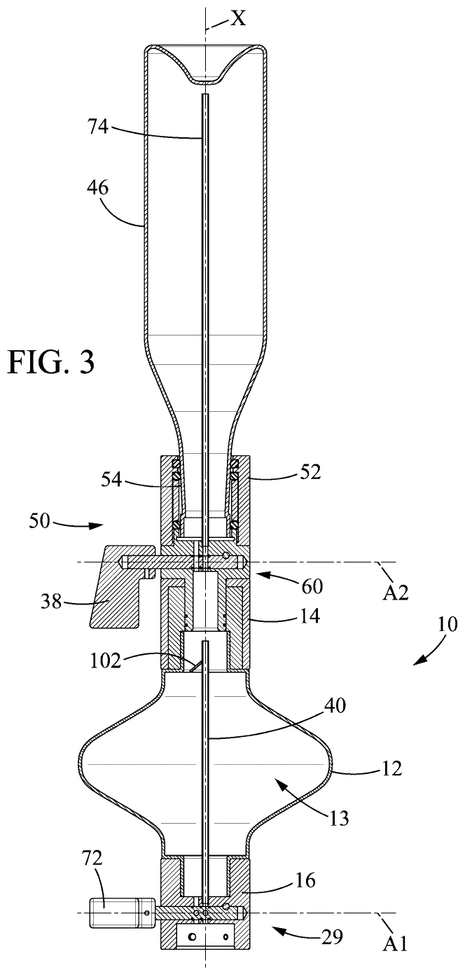

Refill device 10 may be used to transfer at least one liquid, in particular wine or a spirit such as cognac, from a refill container 46 to a final container 48. As illustrated in FIG. 3, a first mounting adapter 50 is used here to facilitate linking refill container 46 to refill device 10, in particular to first endpiece 14. First adapter 50 here is detachable from first endpiece 14. This facilitates the manipulation required in order to transfer the liquid into hollow body 12. Alternatively, however, first adapter 50 may be integral (i.e. rigidly fixed) to first endpiece 14.

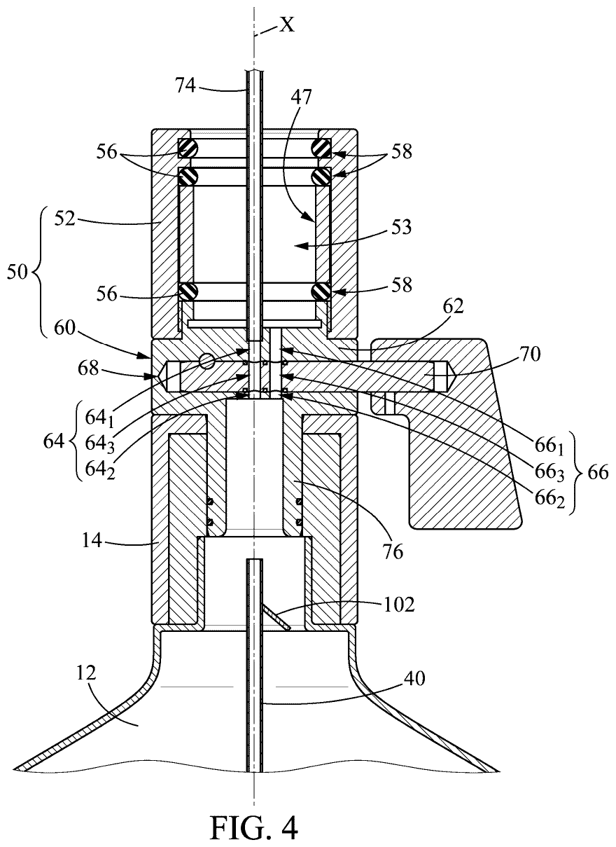

First adapter 50 comprises, as illustrated for example in FIG. 4, a ring 52 for receiving neck 54 of refill container 46. Ring 52 thus forms a housing 53 for receiving neck 54 of refill container 46. Here, to ensure liquid-tightness and preferably gas-tightness, in particular air-tightness, seals 56 are used, which are clamped between neck 54 of refill container 46 and internal cylindrical surface 47 of ring 52, defining housing 53. Here, three seals 56 are used. Here, the seals 56 used are O-rings. Advantageously, inner cylindrical wall 47 of ring 52 defining housing 53 forms grooves 58, each receiving a respective seal 56.

First adapter 50 also comprises a double valve 60. Here, valve 60 consists of a cylindrical valve body 62, in which are formed the first and second sections 64₁, 66₁, 64₂, 66₂ of pipes 64, 66. First 64₁, 66₁ and second 64₂, 66₂ sections of a same pipe 64, 66 are at a distance from each other, separated by a hollow cylindrical housing 68 receiving a cylindrical rod 70. Rod 70 is pivotable within hollow cylindrical housing 68 about a second axis A2 comprised in a plane normal to axis of extension X of refill device 10. Third sections 64₃, 66₃ of pipes 64, 66 are formed in rod 70. Thus, by pivoting rod 68, each of first pipe sections 64₁, 66₁ is selectively placed in fluid communication with the respective second section 64₂, 64₃. Advantageously, seals are arranged, in particular O-rings, along rod 70 so that the fluid communication is liquid-tight and preferably gas-tight, in particular air-tight. Here three seals are used, of which one is arranged along rod 70 between the two third sections 64₃, 66₃ of pipes. Rod 70 is integral with a gripping piece 72 to facilitate manipulation, in particular rotation about axis of rotation A2 of rod 70.

In the illustrated example, one 64 of pipes 64, 66 extends substantially along axis of extension X of refill device 10. Thus, when adapter 50 is put in place on first endpiece 14, pipe 64 is arranged substantially face to face with tube 40 passing through hollow body 12. In contrast, the other pipe 66 is in a position that is transversely offset relative to tube 40.

Pipe 64, extending substantially along axis of extension X of refill device 10, in particular first section 64₁ of pipe 64, is further extended, in the direction opposite to the direction towards hollow body 12, by a tube 74. Tube 74 is of a length such that it is adapted to have a mouth facing, and at or near the bottom of, refill container 46 when the latter is linked to first adapter 50. In contrast, the other pipe 66, in particular first section 66₁ of other pipe 66, has a mouth opening into housing 53 for receiving neck 54 of refill container 46, formed in ring 52.

Valve 60 comprises, on its opposite surface to ring 52, a protruding hollow relief 76 of a shape complementary to housing 22 in first endpiece 14 of refill device 10, thus enabling relief 76 to be accommodated. Relief 76 therefore allows linking the assembly formed by refill container 46 on which first adapter 50 is fixed, to the rest of refill device 10, by the complementary shapes of housing 22 and first endpiece 14. One or more seals may be interposed between relief 76 and the cylindrical wall of receiving housing 22 in first endpiece 14, to ensure liquid-tightness and preferably gas-tightness, in particular air-tightness. Here, two seals are used, in particular two O-rings. Pipes 64, 66 lead into hollow relief 76.

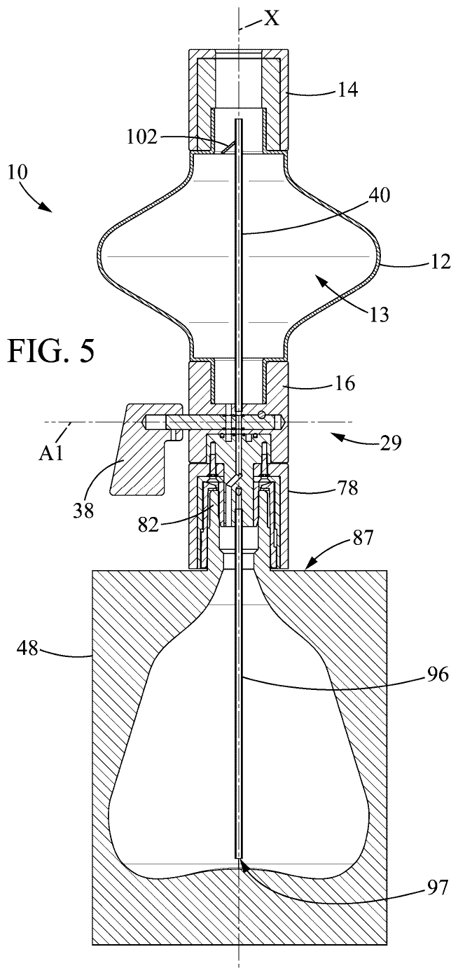

Similarly and as illustrated in FIG. 5 for example, a second adapter 78 here is implemented to facilitate the linking of final container 48 to refill device 10, and consequently the transfer from inside hollow body 12 to final container 48. Second adapter 78 here is detachable from second endpiece 16. This facilitates the manipulations necessary for the transfer of liquid from the inside of hollow body 12 to final container 48. Alternatively, however, second adapter 78 may be integral (i.e. rigidly fixed) to second endpiece 16.

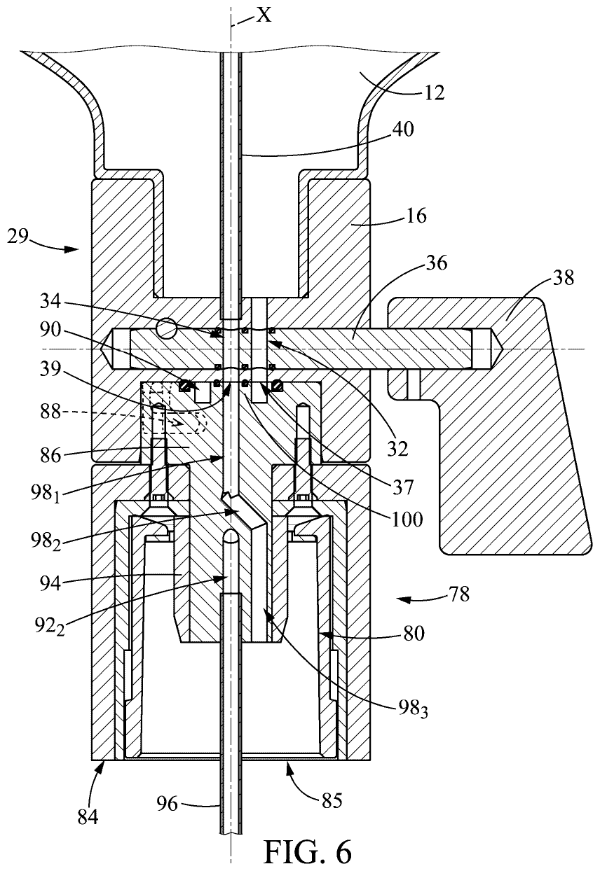

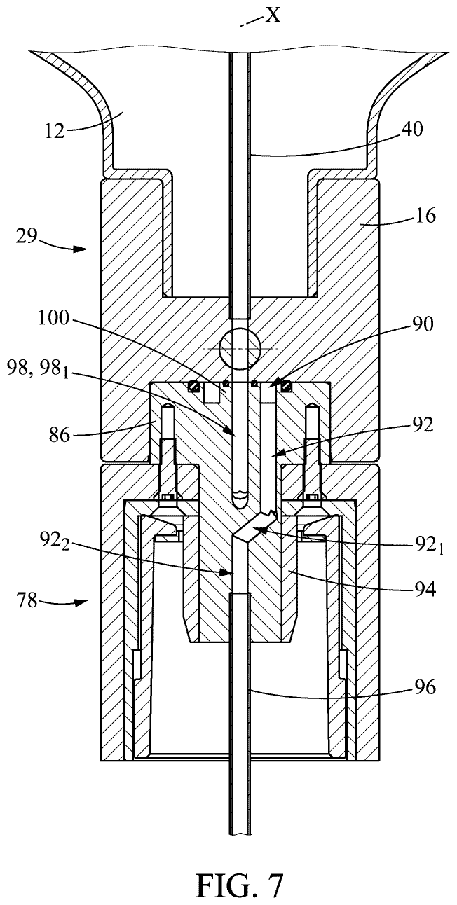

As illustrated in FIG. 6 and FIG. 7 in particular, second adapter 78 forms a housing 80 for receiving neck 82 of final container 48. In particular, frontal surface 84 of second adapter 78, surrounding mouth 85 of housing 80, is preferably shaped to rest flat on a complementary surface 87 of final container 48, surrounding neck 82 of final container 48. Here, frontal surface 84 extends in a plane normal to axis of extension X of refill device 10. Alternatively, however, frontal surface 84 may be inclined, in a section view along a longitudinal plane of refill device 10.

Furthermore, second adapter 78 forms a first projecting relief 86 adapted to be received in second housing 28 of second endpiece 16. Preferably, projecting relief 86 is of a shape substantially complementary to the shape of housing 28 of second endpiece 16. Here, first projecting relief 86 is of generally cylindrical shape, its axis corresponding to the axis of extension X of refill device 10. Grooves 88 are made in first projecting relief 86, each adapted to receive a pin 44 protruding from second housing 28 of second endpiece 16. Grooves 88 are shaped to allow second adapter 78 to be fixed to second endpiece 16 by engaging with pins 44. Second adapter 78 is thus fixed to second endpiece 16 by a bayonet (or quarter-turn) type of attachment. Of course, other means of fixing second adapter 78 in second housing 28 of second endpiece 16 may be implemented.

First projecting relief 86 forms a circular groove 90, its mouth being at the frontal end of first projecting relief 86. The axis of circular groove 90 is here axis of extension X of refill device 10. A mouth of a first pipe 92 leads into circular groove 90. First pipe 92 is formed in first projecting relief 86 and in a second projecting relief 94 of second adapter 78, the latter relief protruding into housing 68 of second adapter 78 where neck 82 of final container 48 is to be received. Second projecting relief 94 is adapted to be received inside neck 82 of final container 48, when second adapter 78 is fixed to final container 48. First pipe 92 is advantageously liquid-tight and preferably gas-tight, in particular air-tight. First pipe 92 is further extended from second projecting relief 94 by a tube 96. Tube 96 is preferably of a length such that mouth 97 of tube 96 leading into final container 48, when second adapter 78 is mounted on final container 48, is arranged facing and at a distance from the bottom of final container 48. Preferably, the distance between mouth 97 of tube 96 and the bottom of final container 48 is less than or equal to 1 cm.

In the example illustrated in FIG. 7, first pipe 92 comprises, in second projecting relief 94, a section 921 extending at an angle relative to axis of extension X of refill device 10. First pipe 92 is further extended, from angled section 921, by a section 922 extending along axis of extension X of refill device 10. Thus, tube 96 extends along axis of extension X of refill device 10.

Furthermore, a second pipe 98 is formed in second adapter 78. Second pipe 98 has a mouth at one end, which leads to the center of relief 100 delimited by groove 90 in first projecting relief 94. Second pipe 98 thus extends, in a first section 981, along direction of extension X of refill device 10. However, second pipe 98 here comprises a second section 982 that is angled relative to direction of extension X of refill device 10, in a view in a longitudinal section plane of refill device 10 (see FIG. 6). Second pipe 98 lastly comprises a third section 983 extending from second section 982 to a mouth of second pipe 98 at the free end of second projecting relief 94. Third section 983 here extends parallel to axis of extension X of refill device 10.

The transfer of at least one wine or spirit from refill container 46 to final container 48 may in particular be carried out by implementing the method described below.

Firstly, first adapter 50 is placed on refill container 46. To do so, neck 54 of refill container 46 is placed in housing 53 provided for this purpose in first adapter 50, tube 74 then being received in refill container 46. Seals 56 ensure that the mounting of neck 54 in housing 53 is sealed.

Valve 60 of first adapter 50 being closed, the assembly formed by refill container 46 and first adapter 50 is then placed on refill device 10. This is achieved by placing relief 76 of first adapter 50 in housing 22 of first endpiece 16 of refill device 10. Seals ensure that the reception of relief 76 in housing 22 is sealed. Since valve 29 of second endpiece 16 is closed, valve 60 of first adapter 50 may then be opened. The configuration of FIG. 3 is thus achieved.

In this configuration, refill container 46 is emptied of the liquid it contains via pipe 66, here offset transversely relative to axis of extension X of refill device 10. The liquid falls from pipe 66 to inside hollow body 12 of refill device 10. Here, however, to prevent the liquid from falling too far, which could shake up the transferred liquid and alter it, a baffle 102, here fixed to tube 40 and extending into cavity 42 formed by first endpiece 14, is arranged in the path of the liquid. The liquid is thus directed towards the wall of hollow body 12. The wall of hollow body 12 then guides the liquid, which allows a more gentle transfer of the liquid from refill container 46 to the inside of hollow body 12, protecting the taste and mouthfeel of the transferred liquid.

Simultaneously, initial container 46 fills with air which was initially contained inside hollow body 12. The air is expelled from hollow body 12 by the liquid coming from refill container 46. The air is then forced to travel through pipe 64 to tube 74. Thus, the air passes through refill container 46 without coming into contact with the liquid contained in refill container 46, in particular without air bubbles appearing in this liquid contained in refill container 46. This contributes to maintaining the taste and mouthfeel of the liquid contained in refill container 46.

Once refill container 46 has been completely emptied into hollow body 12 of refill device 10, the assembly formed by refill container 46 and first adapter 50 may be detached from the refill device. Alternatively, this assembly may remain linked to refill device 10.

Second adapter 78 is then put in place on final container 48. This is done by placing neck 82 of final container 48 in housing 80 provided for this purpose in second adapter 78. Second projecting relief 94 is then received in neck 82 of final container 48 and tube 96 extends through final container 48.

The assembly formed by final container 48 and second adapter 78 is then associated with refill device 10. To do so, here, refill device 10 is fixed to second adapter 78 by receiving first projecting relief 86 of second adapter 78 in housing 28 provided for this purpose in second endpiece 16 of refill device 10, which allows a bayonet-type of attachment.

Valve 29 formed in second endpiece 16 of refill device 10 may then be opened to transfer the liquid contained inside hollow body 12 to inside final container 48. The configuration illustrated in FIG. 5 is thus obtained.

In this configuration, the liquid escapes from refill device 10 through an orifice 37 of the refill device, offset transversely relative to axis of extension X of refill device 10. The liquid then passes through groove 90 at the frontal end of first projecting relief 86 of second adapter 78, to pipe 92. Pipe 92 then guides the liquid through first and second projecting reliefs 86, 94 of second adapter 78, all the way to tube 96. Tube 96 in turn guides the liquid to inside final container 48, in particular towards the bottom of the interior of final container 48. This allows moving the liquid while limiting or even eliminating the risks of rough movement.

Simultaneously, final container 48 is emptied of air which fills hollow body 12 of refill device 10. The air contained in final container 48 is expelled by the liquid gradually filling final container 48. More precisely, the air is expelled towards pipe 98 formed in second adapter 78, to pass through orifice 39 of second endpiece 16. The air continues its path through pipe 34 and tube 40 to the inside of hollow body 12. The air thus fills hollow body 12 by passing through the liquid contained in body 12, via tube 40, therefore without coming into contact with the liquid. This prevents the appearance of gas bubbles in the liquid contained in the hollow body, which could alter the liquid.

The invention is not limited to the embodiment described above.

On the contrary, the invention is susceptible to numerous variants accessible to those skilled in the art.

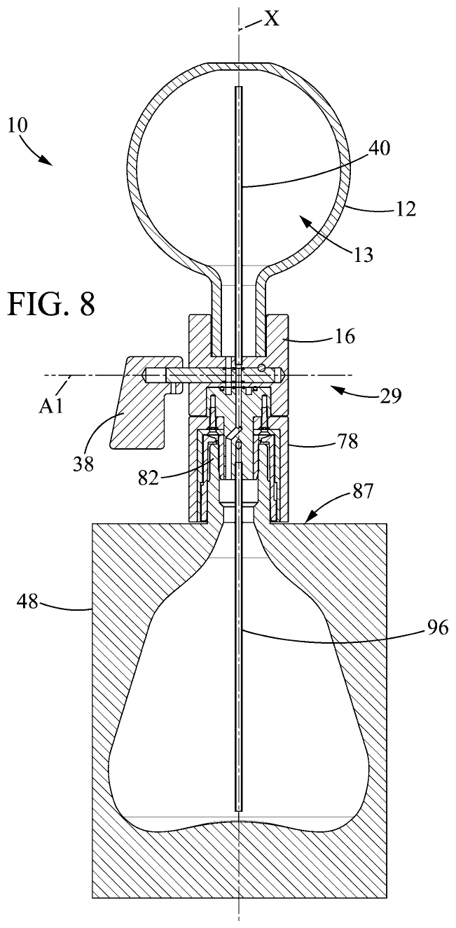

Thus, as can be seen in FIG. 8, refill device 10 may comprise a hollow body 12 with a single mouth 18 on which is fixed an endpiece 16 forming the two orifices 37, 39 mentioned in the previous example. In this case, refill device 10 may advantageously be filled with a liquid intended to be transferred into a final container 48, before endpiece 16 is put in place. For example, hollow body 12 may be temporarily plugged by means of a stopper. Once the stopper is removed, endpiece 16 is put in place on the end of hollow body 12, forming the single mouth 18. Endpiece 16 here is identical to second endpiece 16 of the previous example. The transfer of liquid from hollow body 12 is carried out as described above.

Alternatively, mouth 18 of hollow body 12 is sealed in a liquid-tight manner, and preferably in a gas-tight manner, in particular in an air-tight manner, by a cover or a membrane, and endpiece 16 comprises means for piercing this cover or this membrane and thus placing the two orifices 37, 39 in fluid communication with reservoir 13 inside hollow body 12.

In both cases, hollow body 12 advantageously has a substantially spherical shape, preferably flattened at one end which is opposite to mouth 18.

Furthermore, unlike the examples described above, the adapters may be integral (i.e. rigidly fixed) to refill device 10. In this case, in particular, it may be envisaged to perform the transfer while keeping refill container 46 and final container 48 linked to refill device 10 throughout the transfer operation.

Also, in the illustrated example, all the liquid contained in refill container 46 and nothing but this liquid is used to fill a final container 48. According to one variant, however, the refill device may be used to transfer some or all of the liquid contained in different refill containers 46 into a same final container 48. The refill device then allows easy assembly of different liquids, in particular different wines or spirits, in final container 48.

Also, different capacities of hollow body 12 may be envisaged, corresponding to the volume of liquid contained in a refill container or to a multiple of the volume of liquid contained in a refill container, in order to refill the final container from several refill containers by means of a single refill device 10.

It may also be envisaged to refill a final container from several refill devices 10. In this case, for example, each refill device 10 comprises a hollow body 12 adapted to contain only a portion of the liquid to be ultimately transferred into the final container.

It should be noted that refill device 10, as illustrated in the figures, is without any inflatable body inside hollow body 12. Refill device 10 thus allows direct contact between the air and the liquid contained in hollow body 12. Refill device 10 however prevents air bubbles from passing through the liquid contained in the hollow body, which could alter the liquid contained in the hollow body.

Furthermore, in the examples described, first adapter 50 and second adapter 78 each form a housing for receiving the neck of refill container 46 and final container 48, respectively. Alternatively, at least one among first adapter 50 and second adapter 78 is without any such housing for receiving a neck. In this case, preferably first adapter 50 and/or second adapter 78 comprises a projecting relief shaped for insertion into the neck of refill container 46 and final container 48 respectively. The projecting relief is for example frustoconical. The projecting relief is advantageously made of a material that is elastically deformable during insertion into the neck, in order to ensure the positioning of the refill device relative to refill container 46 or to final container 48 respectively, and preferably the liquid-tightness, and more preferably gas-tightness, of the reception of the projecting relief in the neck of refill container 46 or of final container 48.

Finally, in the examples illustrated, valve body 62 is attached between ring 52 and first endpiece 14. Alternatively, valve body 62 is integral with at least one among ring 52 and first endpiece 14.

1. A refill device for refilling a final container with at least one wine or spirit, comprising a hollow body forming a reservoir, and, at or near a first end of the hollow body, separate first and second orifices which are in fluid communication with the reservoir, the first orifice being in fluid communication with the reservoir via a tube extending through the reservoir.

2. The refill device according to claim 1, wherein the first and second orifices are formed in a first endpiece fixed to the first end of the hollow body.

3. The refill device according to claim 2, wherein the first endpiece forms a valve for selectively placing the first orifice in fluid communication with the tube and the second orifice with the reservoir.

4. The refill device according to claim 3, wherein the first endpiece forms a first pipe adapted to place the first orifice in fluid communication with the tube, and a second pipe adapted to place the second orifice in fluid communication with the reservoir, a rod which forms a section of each of the first and second pipes being pivotally mounted relative to the first endpiece, for selectively allowing or blocking fluid communication through the first and second pipes.

5. The refill device according to claim 1, wherein the hollow body extends primarily in a main direction of extension, the hollow body having a dimension in the main direction of extension that is less than or equal to its dimensions in two directions perpendicular to the main direction of extension.

6. The refill device according to claim 5, wherein the hollow body is rotationally symmetrical relative to an axis extending parallel to the main direction of extension.

7. The refill device according to claim 1, further comprising a first mounting adapter for mounting on a final container.

8. The refill device according to claim 7, wherein the first mounting adapter forms a housing for receiving one end of the final container.

9. The refill device according to claim 7 or 8, wherein the first mounting adapter forms third and fourth pipes each adapted to place the first or second orifice respectively in fluid communication with the interior of the final container.

10. The refill device according to claim 1, wherein the hollow body is without any orifices other than the first and second orifices.

11. The refill device according to claim 1, wherein the hollow body forms a third orifice, near a second end of the hollow body, the third orifice being in fluid communication with the reservoir.

12. The refill device according to claim 13, wherein the third orifice is formed in a second endpiece, fixed to the second end of the hollow body.

13. The refill device according to claim 13, comprising a baffle shaped to direct the at least one wine or spirit passing through the second orifice, towards a wall of the hollow body.

14. The refill device according to claim 13, comprising a second mounting adapter for mounting at least one refill container on the refill device.

15. The refill device according to claim 18, wherein the second mounting adapter forms a housing for receiving one end of the refill container.

16. The refill device according to claim 18, wherein the second mounting adapter forms a fifth pipe adapted to place the housing for receiving one end of the refill container in fluid communication with the third orifice.

17. The refill device according to claim 18, wherein the second mounting adapter forms a sixth pipe adapted to place the third orifice in fluid communication with a tube intended to extend through the refill container received in the second mounting adapter.

18. The refill device according to claim 20, wherein the second mounting adapter forms a valve which allows selectively cutting off the fluid communication through the fifth pipes.

19. The refill device according to claim 2, wherein the first endpiece, is made of stainless steel.

20. The refill assembly for refilling a final container with at least one wine or spirit, comprising a refill device according to claim 12, and a final container.

21. The refill assembly for refilling a final container with at least one wine or spirit, comprising a refill device according to claim 14, and at least one among at least one refill container and one final container, the refill assembly preferably comprising at least one refill container and one final container.

22. A method for refilling a final container with at least one wine or spirit from at least one refill container, comprising the steps of:
a) at least partially emptying the at least one refill container into the reservoir formed by the hollow body of a refill device according to claim 14, through the third orifice of the refill device; then
b) filling the final container from the refill device, through the first orifice.

23. A method for refilling according to claim 26, comprising an intermediate step between steps a) and b), consisting of separating the at least one refill container from the refill device, and, linking the final container to the refill device.

24. A refill device according to claim 7, wherein the first mounting adapter is detachable from the hollow body.

25. A refill device according to claim 7, wherein the second orifice is further in fluid communication with the interior of the final container via a tube intended to extend through the final container.

26. A refill device according to claim 11, wherein the main direction of extension corresponding to the direction from the first end towards the second end of the hollow body.

27. A refill device according to claim 14, wherein the second mounting adapter is detachable from the hollow body.
